(19) United States
(12) Patent Application Publication
(10) Pub. No.: US 2024/0104947 A1
(43) Pub. Date: Mar. 28, 2024

(54) SYSTEMS AND METHODS FOR CLASSIFYING FOOD PRODUCTS

(71) Applicant: MARS, INCORPORATED, McLean, VA (US)

(72) Inventors: Mark Justin PARKINSON, Newark, NJ (US); Michael Wolfgang FITZKE, Verden (DE); Jana FAERBER (nee HASEMANN), Verden (DE); Matthew PERKINS, Slough (GB); Brent KLINE, Chicago, IL (US); Brian ANTHONY, Chicago, IL (US)

(21) Appl. No.: 18/267,004

(22) PCT Filed: Dec. 14, 2021
(86) PCT No.: PCT/US21/63374

§ 371 Date: Jun. 13, 2023

Related U.S. Application Data
(60) Provisional application No. 63/125,283, filed on Dec. 14, 2020.

(30) Foreign Application Priority Data
Dec. 14, 2020 (US) 63125283

(51) Int. Cl. G06V 20/68; G06T 7/00; G06T 7/11; G06V 10/26; G06V 10/764; G06V 10/94

(52) U.S. Cl. CPC G06V 20/68; G06T 7/0004; G06T 7/11; G06V 10/26; G06V 10/764; G06V 10/95; G06T 2207/20021; G06T 2207/20081; G06T 2207/20084; G06T 2207/30128

(57) ABSTRACT

One example method provided herein comprises: receiving an input image from a client device, the input image comprising a view of one or move products, wherein the input image comprises a plurality of pixels; generating, using a trained machine learning model, a bounding box for each of the one or more products, respectively, each bounding box comprising a subset of the plurality of pixels, wherein each bounding box indicates a particular product of the one or more products; generating a segmentation M mask for the pixels within each of the bounding boxes; generating, using each segmentation mask, an isolated image of each product indicated by one of the bounding boxes, wherein each isolated image comprises substantially only a set of pixels representing the indicated product; generating, using each isolated image of each product, a classification of each of the one or more products; and displaying information related to the generated classifications.

### BENEFIT CLAIM

This application claims the benefit under 35 U.S.C. § 1.19 of provisional application 63/125,283 filed Dec. 14, 2020, the entire contents of which is hereby incorporated by reference as if fully set forth herein.

### TECHNICAL HELD

This disclosure generally relates to using machine teaming systems to process food product information.

### BACKGROUND

Confectionaries receive many metric tons of cocoa beans annually. The cocoa bean is one of the main components of chocolate products and sweets manufactured by confectionaries. To ensure a consistent and quality product, the received batches of cocoa beans are assessed and sorted based on a number of factors, including the freshness of the beans themselves. Currently, this process is time consuming anal can require visual inspections during various points in the supply chain. Additionally, the reliance on visual inspections can lead to potential inconsistencies in the quality control of the cocoa beans due to the subjective nature of such inspections. Thus, there is a need in the industry to automate the quality control and assessment of confectionary products, or components of confectionary products, throughout the supply chain to reduce time and labor costs and increase consistency in evaluations. A similar automation is needed for pet food products.

### SUMMARY OF PARTICULAR EMBODIMENTS

Certain non-limiting embodiments provide systems, methods, and media for using machine learning systems to classify food products. Certain non-limiting embodiments can be directed to a computer-implemented method. The computer-implemented method can include one or more of: receiving an input image from a client device, the input image comprising a view of one or more products, wherein the input image comprises a plurality of pixels; generating, using a trained machine learning model, a bounding box for each of the one or more products, respectively, each bounding box comprising a subset of the plurality of pixels, wherein each bounding box indicates a particular product of the one or more products; generating a segmentation mask fair the pixels within each of the bounding boxes; generating, using each segmentation mask, an isolated image of each product indicated by one of the bounding boxes, wherein each isolated image comprises substantially only a set of pixels representing the indicated product; generating, using each isolated image of each product, a classification of each of the one or more products; and displaying information related to the generated classifications.

In one embodiment, the machine learning model was trained using a collection of annotated images, each annotated image of the collection of annotated images comprising a view of a set of products of a product type of the one or more products.

In one embodiment, the one or more products comprise one or more cocoa beans.

In one embodiment, the one more cocoa beans comprise wet beans.

In one embodiment, at least one of the classifications of one of the products comprises one of acceptable, germinated, damaged by pests, or diseased.

In one embodiment, at least one of the classifications of one of the products relates to freshness.

One embodiment further comprises predicting a Brix measurement for one or more of the one or more products, wherein at least one of the classifications of one of the products is based at least in part on the predicted Brix measurement.

One embodiment further comprises: predicting a Brix measurement for one or more of the one or more products; and generating a quality score tear one or more of the one Or more products based at least in part on the predicted Brix measurement.

In one embodiment, the one more cocoa beans comprise dry beans.

In one embodiment, at least one of the classifications of one of the products is at least partly based on a predicted quality comprising one of an amount of moisture, a Cut Test: Clumps test result, a Cut Test: Mold test result, a cut Test: Flats test result, a Cut Test: Color test result, a Cut Test: Infestation test result, a bean size, a Foreign Matter test result, an indication of a broken bean, or a bean count.

One embodiment further comprises receiving one or more additional inputs, herein the one or more additional inputs comprise at least one of an origin, an age, a variety, a price, a harvesting method, a processing method, a weight, or a fermentation method, and wherein the classification is at least partly based on the one or more additional inputs.

In one embodiment, the one or more products comprise pet food, and wherein the pet food comprises at least one of a dry pet food or a wet pet food.

One embodiment further comprises receiving one or more updates to the trained machine learning model over the network, wherein the network comprises a cloud server.

One embodiment further comprises: generating a recommendation to reject one of a batch or a shipment of cocoa beans based at least in part on the classification of each of the one or more products; and displaying the recommendation on the client device.

One embodiment further comprises generating and displaying a confidence score, wherein the confidence score is associated with the one of the classifications of one of the products.

Certain non-limiting embodiments can be directed to computer-readable non-transitory storage media comprising instructions operable when executed by one or more processors to cause a system to perform any of the methods or techniques described herein.

Certain non-limiting embodiments can be directed to a system, which can include one or more processors, one or more computer-readable non-transitory storage media coupled to one or more of the processors and comprising instructions operable when executed by one or more of the processors to cause the system to perform any of the methods or techniques described herein.

The embodiments disclosed herein are only examples, and the scope of this disclosure is not limited to them. Certain non-limiting embodiments can include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

In the drawings:

FIG. 1 illustrates an example of a framework for predicting a quality of one or more products in some non-limiting embodiments.

FIG. 2A depicts a sample training image according to certain non-limiting embodiments.

FIG. 2B depicts the result of applying a segmentation mask to the training image according to some non-limiting embodiments.

FIG. 2C depicts displaying information related to a predicted classification of the one or more products depicted in the training image according to some non-limiting embodiments.

FIG. 3A depicts a sample input image received by a trained CNN, according to certain non-limiting embodiments.

FIG. 3B depicts displaying information related to a predicted classification of the one or more products depicted in the input image according to some non-limiting embodiments,

FIG. 3C depicts displaying information related to a predicted classification of the one or more products depicted in the input image, including corresponding confidence scores, according to some non-limiting embodiments.

FIG. 4 illustrates an example computer-implemented method for using machine learning systems to classify confectionary or pet food products according to certain non-limiting embodiments.

FIG. 5 illustrates an example computer system or device used to facilitate prediction of product classifications using machine learning tools, according to certain non-limiting embodiments.

### DESCRIPTION OF EXAMPLE EMBODIMENTS

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and to make and use them.

As used in the specification and the appended claims, the singular forms “an” and “the” include plural referents unless the context clearly dictates otherwise.

As used herein, the terms “comprises.” “comprising,” or any other variation thereof are intended to cover a non-exclusive inclusion, such that a process, method, article, system, or apparatus that comprises a list of elements does not include only those elements but can include other elements not expressly listed or inherent to such process, method, article, or apparatus.

As used herein, the tem “product” as used in accordance with the present disclosure refers to any confectionary product or any pet food product, its derivatives, or a raw material used to create the confectionary or food product as described herein. For example, the “product” can refer to a cocoa bean used to prepare the confectionary product.

As used herein, “cocoa beans” refer to the beans derived from the fruit pods of Theobroma cacao that are the principal raw material for chocolate production.

As used herein, the cocoa beans are derived from species of the genera Theobroma or Herrania or inter- and intra-species crosses thereof within those genera, and more preferably from the species Theobroma cacao and Theobroma grandiflorum. The species Theo/?coma cacao as used herein comprises all genotypes, particularly all commercially useful genotypes, including but not limited to Criollo, Forastero, Trinitario, Arriba, Amelonado, Coritamana, Curaray, Guiana, Iquitos, Maranon, Nacional, Nanay, and Purus and crosses and hybrids thereof.

The terms “cocoa” and “cacao” as used herein are considered as synonyms. As used herein, the term “confectionery” or “confectionery product” an edible composition. Confectionery products can include, but are not limited to fat-based and non-fat based confectionery, snacks, breads, baked goods, crackers, cakes, cookies, pies, candies (hard and soft), compressed mints, chewing gums, gelatins, ice creams, sorbets, jams, jellies, chocolates, fudge, fondant, liquorice, taffy, hard candies, chewy candies, coated chewy center candies, tableted candies, nougats, dragees, confectionery pastes, gums, chewing gums and the like and combinations thereof.

As used herein, the term. “chocolate” refers to a chocolate product conforming to the applicable country-based standard of identity, including but not limited to U.S. Standards Of identity (SOI), European Standards of Identity, CODEX Alimentarius, and the like, as well as non-conforming chocolates and chocolate-like products, e.g. comprising cocoa butter replacers, cocoa butter equivalents or substitutes), compound chocolate, a coating chocolate, a chocolate-like coating product, a coating chocolate for ice-creams, a chocolate-like coating for ice-cream, a praline, a chocolate filling, a fudge, a chocolate cream, an extruded chocolate product or the like. The fat-based confectionery product can be a white chocolate; the white chocolate comprising sugar, milk powder and cocoa butter without dark cocoa solids. The product can be in the form of an aerated product, a bar, or a filling, among others. The chocolate products or compositions can be used as coatings, tillers, enrobing compositions or other ingredients in a finished or final food or confectionery product. The confectionery product of the disclosed subject matter can further contain inclusions such as nuts, cereals, and the like.

As used herein, the terms “animal” or “pet” as used in accordance with the present disclosure refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “animal” or “pet” as used in accordance with the present disclosure can further refer to wild animals, including, but not limited to bison, elk, deer, venison, duck, fowl, fish, and the like.

As used herein, the terms “animal feed,” “animal feed compositions,” “pet food,” “pet food article,” or “pet food composition” are used interchangeably herein and refer to a composition intended for ingestion by an animal or pet. Pet foods can include, without limitation, nutritionally balanced compositions suitable for daily feed, such as kibbles, as well as supplements and/or treats, which can be nutritionally balanced. The pet food can be a pet food providing health and/or nutrition benefits to the pet, e.g., weight management pet foods, satiety pet foods and/or pet foods capable of improving renal function in the pet. In an alternative embodiment, the supplement and/or treats are not nutritionally balanced. In that regard, the terms “animal feed,” “animal feed compositions,” “pet food,” “pet food article,” or “pet food composition” encompass both pet treats and pet primary foods, as defined herein.

As used herein the term “wet pet food” refers to a composition intended for ingestion by a pet. Wet pet food is preferably a nutritionally balanced food product to provide a pet with all the essential nutrients it needs in the appropriate quantities. Typically, wet pet food products contain reconstituted meat material from the reconstitution of animal by-products. Embodiments of the presently disclosed subject matter are particularly directed towards wet pet food, of Which there are two main types.

The first type of wet pet food product is known as ‘paté’ or ‘loaf’ and is typically prepared by processing a mixture of edible components under heat to produce a homogeneous semi-solid mass that is structured by heat-coagulated protein. This homogeneous mass is usually packaged into single serve or multi serve packaging which is then sealed and sterilized. Upon packing, the homogeneous mass assumes the shape of the container.

The second type of wet pet food product is known as ‘chunk-in-gravy’, ‘chunk-in-jelly’ or ‘chunk-in-mousse’, depending on the nature of the sauce component, and these types of products are referred to generically herein as ‘chunk-in-sauce’ products. The chunks comprise meat pieces or, more typically, aesthetically pleasing restructured or reconstituted meat chunks, Restructured meat chunks are typically prepared by making a meat emulsion containing a heat-settable component, and by applying thermal energy to ‘set’ the emulsion and allowing it to assume the desired shape, as described in more detail hereinbelow. The product pieces are combined with a sauce (e.g., gravy, jelly or mousse) in single serve or multi serve packaging which is then sealed and sterilized.

The reconstituted animal material can contain any of the ingredients conventionally used in the manufacture of reconstituted meat and wet pet food products, such as fat(s), antioxidant(s), carbohydrate source(s), fiber source(s), additional source(s) of protein (including vegetable protein), seasoning, colorant(s), flavoring(s), mineral(s), preservative(s), vitamin(s), emulsifier(s), farinaceous material(s) and combinations thereof. The reconstituted animal material can also be referred to as a “meat analogue.”

As used herein, the “quality” of the confectionary or pet food product can be determined based on one or more measurable characteristics of the product. For example, one such “quality” can be the freshness dot it cocoa bean, which is a component of various confectionary products. Other qualities can include color, flavor, texture, size, shape, appearance, or freedom from defects.

As used herein, a “training data set” can comprise various data used to train a machine learning model, along with associated metadata, labels, or ground truth data which can be used to facilitate supervised model training. For example, a training data set can include one or more images along with data or metadata associated with each image, respectively. In a first example, a training data set used to train a machine learning classifier to determine if a cocoa bean is fresh can comprise two subsets of images. The first image subset might comprise images of cocoa beans each labeled with a first label indicating freshness. The second image subset might comprise an assortment of images of cocoa beans each labeled with a second label indicating a lack of freshness. In other embodiments, freshness can not be indicated by a binary ground truth. In these instances, a multi-class classifier can be used to score a cocoa bean on a scale, such as in a range of 1-10. In other instances, the training data and ground truths can be directed to other classifications. For instance, the classification can be directed to classifications of a cocoa bean such as acceptable, germinated, damaged by pests, or diseased. Another example classification can be related to a predicted Brix score or other proxy for freshness, or it could be directed to another quality of a cocoa bean. In a second example, a training data set for an image segmentation tasks might comprise images of cocoa beans each associated with a ground truth of a pixel grid of 0's and 1's to indicate which pixels in the training image correspond to cocoa beans. Such a pixel grid can be referred to as a segmentation mask. Similarly, a machine learning model can be trained to predict bounding boxes using a labeled training data set comprising some images of cocoa beans surrounded by bounding boxes and some images with no cocoa beans and no bounding boxes. A training data set can include one or more imageS or videos of confectionary or pet food products. For example, the one or more images can be captured images of a bath of cocoa beans taken throughout the supply chain. A training data set can be collected via one or more client devices (e.g., crowd-sourced) or collected from other sources (e.g., a database). In some embodiments, a labeled training data set is created by human annotators, while in other embodiments a separate trained machine learning model can be used to generate a labeled data set

In the detailed description herein, references to “embodiment,” “an embodiment,” “one embodiment,” “in various embodiments,” “certain embodiments,” “some embodiments,” “other embodiments,” “certain other embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described, After reading the description, it will be apparent to one skilled in the relevant art(s) how to implement the disclosure in alternative embodiments.

As used herein, the term “client device” refers to a computing system or mobile device used by a user of a given mobile application. For example, the term “client device” can include a smartphone, a tablet computer, or a laptop computer. In particular, the computing system can comprise functionality for determining its location, direction, or orientation, such as a GPS receiver, compass, gyroscope, or accelerometer. Client device can also include functionality for wireless communication, such as BLUETOOTH communication, near-field communication (NFC), or infrared (IR) communication or communication with wireless local area networks (WLANs) or cellular-telephone network. Such a device can also include one or more cameras, scanners, touchscreens, microphones, or speakers. Client devices can also execute software applications, such as games, web browsers, or social-networking applications. Client devices, for example, can include user equipment, smartphones, tablet computers, laptop computers, desktop computers, or smartwatches.

Example processes and embodiments can be conducted or performed by a computing system or client device through a mobile application and an associated graphical user interface (“UX” or “GUI”), In certain non-limiting embodiments, the computing system or client device can be, for example, a mobile computing system—such as a smartphone, tablet computer, or laptop computer. This mobile computing system can include functionality for determining its location, direction, or orientation, such as a (IPS receiver, compass, gyroscope, or accelerometer. Such a device can also include functionality for wireless communication, such as BLUETOOTH communication, near-field communication (NFC), or infrared (IR) communication or communication with wireless local area networks (WLANs), 3G, 4G, LTE, LTE-A, 5G, Internet of Things, or cellular-telephone network. Such a device can also include one or more cameras, scanners, touchscreens, microphones, or speakers, computing systems can also execute software applications, such as games, web browsers, or social-networking applications. With social-networking applications, users can connect, communicate, and share information with other users in their social networks.

Certain embodiments of the disclosed technology comprise an application program that operates using one or more trained machine learning models. In one embodiment, a user can type in some information about a batch or a shipment of cocoa beans. This information can include measurable attributes or designations such as an origin, an age, a variety, a price, a harvesting method, a processing method, a weight, or a fermentation method associated with the batch or the shipment of cocoa beans, in some embodiments, one or more of these attributes can comprise inputs tor one or more of the trained machine learning models. In particular embodiments, the application can use these input attributes to select more specialized machine learning models to make inferences about the cocoa beans. For example, the application might use one machine learning model trained for Criollo cocoa beans, a different for Forastero cocoa beans, and a different one for Nanay cocoa beans, and the appropriate model can be selected based on the input variety. Each of these respective models can be trained using training data comprising views of cocoa beans of the appropriate variety.

Certain embodiments described herein provide an automated process for predicting and classifying the quality of confectionary and pet food products based on collected data. The quality, for example, can be the freshness of a given product or a component of the product, such as a cocoa bean. The collected data, for example, can be one or more images or videos of the given product. Certain previous methods rely mainly on visual inspection of the product, which is a subjective process that is both time and cost intensive, ln some non-limiting embodiments, a framework is presented to predict the classification and quality (e.g., freshness) of products from collected data using a machine learning model. In certain non-limiting embodiments, a machine learning model, such as K-nearest neighbor (KNN), naïve Bayes (NB), decision trees or random forests, support vector machine (SVM), Transformers, a deep learning model, or any other machine learning model or technique, can be used to predict a given quality of the confectionary or pet food product based on collected data. The machine learning model can be supervised, unsupervised, or semi-supervised. Supervised machine learning can be used to model a function that maps an input to an output based on an example input-output pairs provided by a human supervising the machine learning. Unsupervised machine learning, on the other hand, can be a machine learning model that evaluates previously undetected patterns in a data set without any example input-output pairs. Accordingly, in certain examples cocoa bean freshness can be successfully predicted using a machine learning model that receives images of cocoa beans and analyzes their color. In yet another example, a machine learning model can receive images of a pet food or a wet pet food product, such as a. ‘chunk-in gravy’, ‘chunk-ln-jelly’ or ‘chunk-in-mousse’, and predict using a machine learning model a quality of the food based on one or more characteristics of the detected chunks.

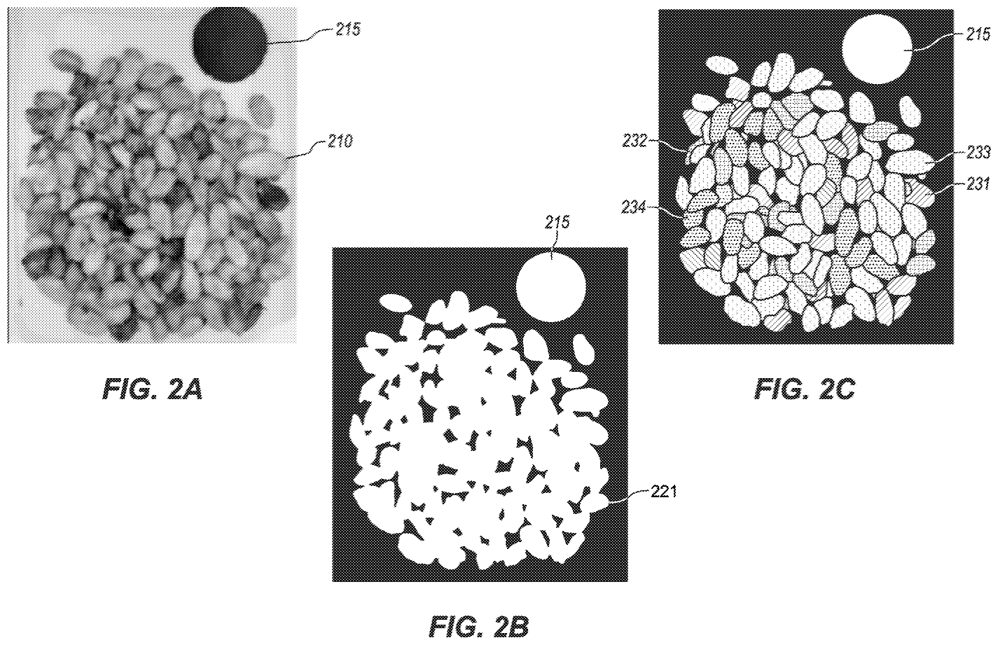

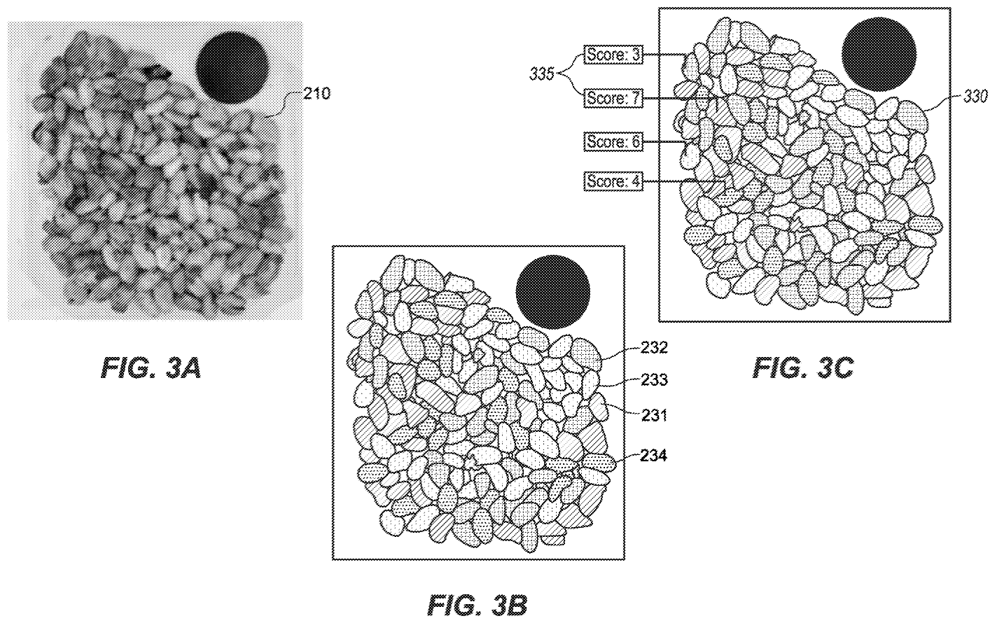

In some g embodiments, the machine learning framework can include a convolutional neural network (CNN) component trained from collected training data of products and corresponding quality and classification scores. The collected training data, for example, can be one or more images captured by a client device. For example, as shown in FIGS. 2A and 3A the one or more images can be a batch of cocoa beans. A CNN is a type of artificial neural network comprising one or more convolutional and subsampling layers with one or more nodes. One or more layers, including one or more hidden layers, can be stacked to form a CNN architecture. Disclosed CNNs can learn to determine image parameters and subsequent classification and quality (e.g., freshness) of products by being exposed to large volumes of labeled training data. While in some examples a neural network can train a learned weight for every input-output pair, CNNs can convolve trainable fixed-length kernels or filters along their inputs. CNNs, in other words, can learn to recognize small, primitive features (low levels) and combine them in complex ways (high levels), Thus, CNNs trained on a synthetic dataset of a particular product allow for accurate object segmentation and product classification and freshness prediction in real images. The CNN can be supervised or non-supervised.

In certain non-limiting embodiments, pooling, padding, and, or striding can be used to reduce the size of a CNN's output in the dimensions that the convolution is performed, thereby reducing computational cost and/or making overtraining less likely. Striding can describe a size or number of steps with which a filter window slides, while padding can include filling in some areas of the data with zeros to buffer the data before or alter striding. Pooling, for example, can include simplifying the information collected by a convolutional layer, or any other layer, and creating a condensed version of the information contained within the layers.

In some examples, a region-based CNN (RCNN) or a one-dimensional (I-D) CNN can be used. RCNN includes using a selective search to identify one or more regions of interest in an image and extracting CNN features from each region independently for classification. Types of RCNN employed in one or more embodiments can include Fast RCNN, Faster RCNN, or Mask RCNN. In other examples, a 1-D CNN can process fixed-length time series segments produced with sliding windows. Such 1-D CNN can run in a many-to-one configuration that utilizes pooling and striding to concatenate the output of the final CNN layer. A fully connected layer can then be used to produce a class prediction at one or more time steps.

As opposed to 1-D CNNs that convolve fixed length kernels along an input signal, recurrent Wind networks (RNNs) process each time step sequentially, so that an RNN layer's final output is a function of every preceding timestep. In certain embodiment, an RNN variant known as long short-term memory (LSTM) model can be used. LSTM can include a memory cell and/or one or more control gates to model time dependencies in long sequences. In some examples the LSTM model can be unidirectional, meaning that the model processes the time series in the order it was recorded or received. In another example, if the entire input sequence is available two parallel LSTM models can be evaluated in opposite directions, both forwards and backwards in time. The results of the two parallel LSTM models can be concatenated, forming a bidirectional LSTM LSTM) that can model temporal dependencies in both directions.

In some embodiments, one or more CNN models and one or more LSTM models can be combined. The combined model can include a stack of four unstrided CNN layers, which can be followed by two LSTM layers and a softmax classifier. A softmax classifier can normalize a probability distribution that includes a number of probabilities proportional to the exponentials of the input. The input signals to the CNNs, for example, are not padded, so that even though the layers are unstrided, each CNN layer shortens the time series by several samples. The LSTM layers are unidirectional, and so the softmax classification corresponding to the final LSTM output can be used in training and evaluation, as well as in reassembling the output time series from the sliding window segments. The combined model can operate in a many-to-one configuration.

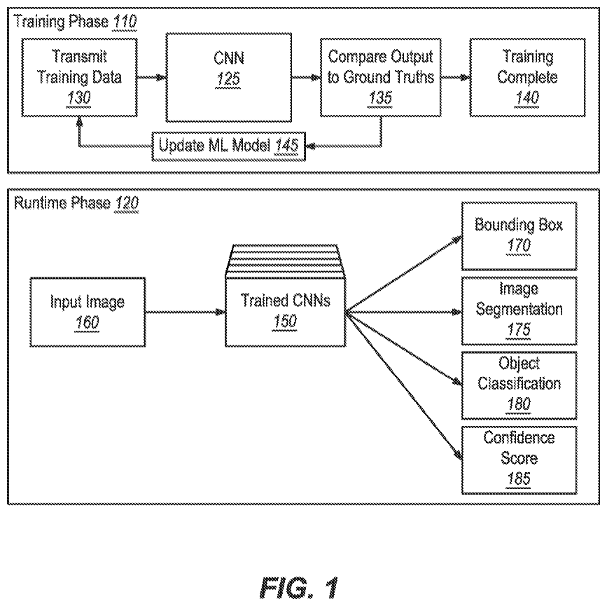

FIG. 1 illustrates an example of a framework for predicting the quality of one or more products in some non-limiting embodiments. In certain non-limiting embodiments, the framework can include a training phase 110 and a runtime phase 120. During the training phase 110, a CNN 125, or any other machine learning model or technique, can be trained to receive one or more training data 130 and ground truths related to predicting a classification or quality score of one or more products depicted in a training image. During training phase 110, each of one or more CNN 125 can be exposed to sets of training data, such as training images to improve the accuracy of its outputs. The images, for example, can be of cocoa bean batches captured by a client device during one or more phases of the supply chain. Each set of training data 130 can comprise a training image of one or more products, associated data, and one or more corresponding ground truths associated with the image. In some embodiments, the associated data is information about the cocoa beans in the form of one or more measurable attributes or objective designations. For example, associated data can include information about the origin, age, variety, price, harvesting method, processing method, weight, or fermentation method of the cocoa beans.

Upon the CNN 125 generating one or more outputs, the outputs can be compared to one or more ground truths 135 associated with the training data. For example, a ground truth can be a Brix score of one or more cocoa beans. In other embodiments, a ground truth can be any other known or expected measure or attribute for a cocoa bean such as the result of one or more lab or field tests. For example, training data can be labeled with results from one or more of the following tests, which can be used to teach, a CNN or other machine learning model to predict the results of the test: (1) Moisture (moisture should not exceed 8.0%), (2) Cut Test: Clumps (a clump exists when two or more beans are joined together, and the two or more beans cannot be separated by using the finger and thumb of both hands), (3) Cut Test: Mold (based on internal mold, by count), (4) Cut Test: Flats (flat beans are too thin to be cut to give a complete surface of the cotyledons), (5) Cut Test: Color (unfermented beans can be defined as a total of purple and slate, by count), (6) Cut Test: Infestation (infested beans can show live insects or signs of insect damage, by count), (7) Bean Size (a percentage of beans that deviate by more than one third of the average weight as found in a test sample), (8) Foreign Matter (when foreign matter on-cocoa material found in a test sample, any mammalian excreta must be less than 10 mg/lb), (9) Shell Content (after beans are dried to <6.0% moisture), (10) Broken Bean (a cocoa bean is broken when a fragment is missing from the cocoa bean and a remaining part of the bean is more than half of the whole bean or (11) Bean Count (defined as beans per 100 grams), In some embodiments, a system can be used to classify on or more cocoa beaus based at least partly on one or more predicted results for one or more of the aforementioned test parameters, which can eliminate a need to actually perform one of these tests manually to generate a system input, in some embodiments, a ground truth can be on a scale, such s a 1-10 scale, a 1-100 scale, or another appropriate scale. A loss, which is the difference between the output and the ground truth can be backpropagated and used to update the parameters of the machine learning model 145 so that the machine learning model 125 can exhibit improved performance when exposed to future data.

After the machine learning model 125 has been improved by updating its model parameters 145, a training iteration can be considered complete. Other embodiments can utilize unsupervised machine learning without one or more ground truths 135. If it is determined the CNN outputs are within a certain degree of accuracy from the corresponding ground truths, training of the CNN can be deemed complete 140. If the CNN outputs are inaccurate, the process can be repeated until the predicted outputs of CNN 125 are sufficiently accurate. Iii certain embodiments, the training phase 110 can be automated and/or semi-automated, meaning that training phase 110 can be supervised or semi-supervised. In semi-automated models, the machine learning can be assisted by a human programmer that intervenes with the automated process and helps to identify or verify one or more trends or models in the data being processed during the machine learning process.

The training data 130 can be collected via one or more client devices (e.g., crowd-sourced) or collected from other sources (e.g., a database), in one non-limiting example, the sets of training data 130 collected from the one or more client devices can be combined with sets of training data from another source. The collected training data 130 can be aggregated and/or classified in order to learn one or more trends or relationships that exist in the data sets. The sets of training data 130 can be synchronized aid/or stored along with the data collected from one or more sensors on a client device, for example a time or location associated with a particular training image. The data comprising the training data can be synchronized manually by a user or automatically. The combined training images and data from the one or more sensors can be analyzed using machine learning or any of the algorithms described herein. Certain images can also be used as validation data or test data. The training data can comprise thousands of images and corresponding ground truths. During training, the parameters of one or more machine learning models can be modified to be able to accurately predict a classification and identify one or more characteristics of food products such as a confectionary product, a pet food product, or one or more cocoa beans. For example, the system of certain embodiments can perform outputting a bounding box 170, an image segmentation of the food product 175, or an object classification 180, and a confidence score 185 can be associated with one or more of these.

In some non-limiting embodiments, each set of training data can comprise a training image and corresponding labels or ground truth data. FIG. 2A depicts a sample training image according to some non-limiting embodiments. An example training input image is depicted in FIG. 2A, As depicted, the training input image can capture OM or more confectionary products or other food products, or components thereof, 210, for example, cocoa beans. The training image can further capture a reference object 215 with known size and shape that can be utilized to determine the size of the one or more confectionary products, cocoa beans, or components thereof, 210 in the training input image. Each training input image as depicted in FIG. 2A can be associated with one or more outputs that serve as ground truths to train the one or more CNNs or other machine learning models. These ground truth outputs can include, for example, a bounding box around each food product in a training image, a segmentation mask of the training image that identifies the pixels of the training image that depict the one or more food products in the training image, a classification score of each of the one or more food products in the training image, or an identification of one or more characteristics of the one or more products in the training image. These characteristics can comprise any of the aforementioned lab or field test parameters, a Brix measurement, or other characteristics or qualities as are described further herein with more specificity. A confidence value or score can be output indicating a probability of the detected input being properly classified by the learned model. The higher the confidence value, the more likely it is that the inputted data is being properly modeled. The confidence value, for example, can represented by a percentage from 0 to 100%, with 0% meaning no confidence and 100% meaning absolute or full confidence. In another embodiment, the confidence value can be an integer on a 1-10 scale, such as 3, 4, 6, or 7.

Although not depicted in FIG. 2, in some non-limiting embodiments, the ground truths can comprise a bounding box around each product in the training image, in one embodiment, the bounding box outputs train the CNN 125 to detect cocoa beans 210 in the training image and to distinguish between, for example, multiple cocoa beans 210 depicted in an image. The bounding box can also be used to crop the image so that only the cropped portion is fed to the next CNN 125 or other model for processing (e.g., a machine learning model programmed to output a segmentation mask will only need to process the pixels within the bounding box, not the entire imago). In embodiments, this process improves the accuracy and performance of the disclosed methods. In practice, one or more CNNs can need to distinguish between cocoa bean 210 in an image to more accurately predict an output for each cocoa bean 210 in the image. In certain non-limiting embodiments, a second CNN can be trained to generate a segmentation mask, which in turn can be used to segment the training image or an image with bounding box(es). The segmentation mask can then be used to subtract the background image data from the foreground image data to isolate the cocoa beans, thereby generating a segmented or isolated image (such as is depicted in FIG. 2B).

FIG. 2B depicts the result of applying a segmentation mask to the training image according to some non-limiting embodiments. In one embodiment, removing the background from the cocoa beans in the image can result in more accurate classification and identification of features of the cocoa beans, without any possible influence or interference from any surrounding objects or background in the original input image. Thus, foreground visual data (e.g., cocoa beans) can be distinguished from background visual data (e.g., a table, tray, bailer, etc.). Notably, in embodiments that use the segmented or isolated images for the classification task, the ground truths used to train the classifier models should also be isolated images of cocoa beans, with backgrounds removed, along with the labels for the appropriate classification(s).

For example, the CNN can be trained using the training sets to process and receive a training input image as depicted in FIG. 2A, and output a segmentation mask which can be applied to FIG. 2A to generate a segmented or isolated image. This segmented or isolated image, which is depicted in FIG. 2R, depicts substantially only one or more instances of cocoa beans 210 in the input image. In some non-limiting embodiments, the segmentation mask can be represented as a two-dimensional matrix, with each matrix element corresponding to a pixel in the training image. Each element's value corresponds to whether the associated pixel belongs to cocoa bean in the image. For example, in the depictions of FIG. 2B and FIG. 2C, the white pixels of the foreground 221 show the location of the objects of interest (the cocoa beans 210), while the black background is left behind after applying the segmentation mask.

In some embodiments, a bounding box can be generated for each cocoa bean and a corresponding segmentation mask can be used for that bean to generate an isolated image of that bean. In these embodiments, each bean can be classified, as is described further herein with more specificity. In some embodiments each isolated image of each classified bean can be color coded by converting each pixel representing that bean (according to the segmentation mask) into a particular color specified to represent the classification. In other embodiments, the bounding box and segmentation mask process can be applied to the image of the one or more food products as a whole.

Although particular data representations for detected cocoa beans and segmentation information are described, this disclosure contemplates any suitable data representations of such information. During training, the outputted segmentation mask can be compared to the ground truth that corresponds to the training image to assess the accuracy of the one or more CNNs or other machine learning models. The ground truth in this instance is a known segmentation mask for the training image.

FIG. 2C depicts displaying information related to a predicted classification of the one or more products depicted in the training image according to some non-limiting embodiments. In one embodiment, the one or more of the products can be cocoa beans which can have been recently removed from pods. Such cocoa beans can be referred to as “wet beans.” For example, as is represented in the black and white FIG. 2C, a cocoa bean classified as “acceptable” (i.e., useable for production) can be colored green, a cocoa bean classified as “germinated” (i.e., unusable for production) can be colored blue, a cocoa bean classified as “pest and diseased” (i.e., unusable for production) can be colored red, and a cocoa bean classified as “other” (e.g., flat cocoa beans) can be colored gray. In FIG. 2C, color is represented by different styles of cross hatching, FIG. 2C depicts: (1) first type cocoa beans 231 with a first type classification (e.g., acceptable) and a first corresponding color, represented by a first cross-hatching style, (2) second type cocoa beans 232 with a second type classification (e.g., germinated) and a second corresponding color, represented by a second cross-hatching style, (3) third type cocoa beans 233, with a third type classification (e.g., pest and diseased) and a third corresponding color, represented by a third cross-hatching style, and (4) fourth type cocoa beans 234, with a fourth type classification (e.g., other) and a fourth corresponding color, represented by a fourth cross-hatching style.

In certain other non-limiting embodiments a quality score for each product can be binary (e.g., “fresh” or “rotten”) or they can be numerical (e.g., a score of 100 corresponds to the freshest cocoa bean, whereas a score of 0 corresponds to the least-fresh cocoa bean). In some non-limiting embodiments, the outputs can further comprise a ground truth Brix measurement of one or more products in the image, or an overall ground truth Brix measurement representing an average of all of the products in the image. A Brix measurement generally represents the amount of sugar in a product and can be obtained by measuring a confectionary or pet food product (e.g., cocoa bean) with a refractometer. For example, a Brix measurement can be taken by putting the cocoa beans into a net, squeezing out the pulp, and then using a refractometer to measure the sugar content of the cocoa beans. 117 certain embodiments, the Brix measurement of a cocoa bean, which can be related to the color and brightness of the cocoa bean, can be used to indicate the freshness of the cocoa bean. Thus, in some non-limiting embodiments, the CNN can be trained to predict the freshness of the cocoa bean without having to manually use a refractometer. In some non-limiting embodiments, system outputs can further comprise a confidence value that corresponds to a classification, quality score, or predicted Brix measurement associated with each product in the image. The confidence value can be a percentage that reflects the likelihood that the CNN made an accurate prediction with regard to the classification, the quality score, or the Brix measurement of each product in the image (e.g., a confidence value of 100 can indicate full-confidence in the output, whereas a confidence value of 0 can indicate no confidence in the output).

In particular embodiments, the one or more products can comprise “dry beans,” and these cocoa beans can also be classified. As opposed to wet beans, dry beans can refer to cocoa beans that have been dried via any drying process, such as by solar drying, drum drying, mechanical drying, or another process. Quality scores or classifications of dry beans can depend on a variety of qualities or test parameters, including: (1) Moisture (moisture should not exceed 8.0%), (2) Cut Test: Clumps (a clump exists when two or more beans are joined together, and the two or more beans cannot be separated by using the finger and thumb of both hands), (3) Cut Test: Mold (based on internal mold, by, count), (4) Cut Test: Flats (flat beans are too thin to be cut to give a complete surface of the cotyledons), (5) Cut Test: Color (unfermented beans can be defined as a total of purple and slate, by count), (6) Cut Test: Infestation (infested beans can show live insects or signs of insect damage, by count), (7) Bean Size (a percentage of beans that deviate by more than one third of the average weight as found in a test sample), (8) Foreign Matter (when foreign matter on-cocoa material found in a test sample, any mammalian excreta must be less than 10 mg/lb), (9) Shell Content (after beans are dried to <6.0% moisture), (10) Broken. Bean (a cocoa bean is broken when a fragment is missing from the cocoa bean and a remaining part of the bean is more than half of the whole bean), or (11) Bean Count (defined as beans per 100 grams). In various embodiments, the aforementioned qualities or test parameters can be used for curating a labeled or annotated data set for training a machine learning model in a supervised or semi-supervised fashion. In particular embodiments, one or more of the provided qualities or test parameters can be used as a ground truth for a specific classification, but others can also be used.

Returning to FIG. 1, once training is complete the computing system can utilize the one or more trained. CNNs during the runtime phase 120. The one or more trained CNNs 150 can be accessed to predict the classification and freshness of products from input images. For example, a new input image 160 of a product can be provided to the trained CNNs 150. The input images 160 could be photographic images, depth images (such as laser scans, millimeter wave data, etc.), 3D data projected into a 2D plane, thermal images, 2D sensor data, video, or any combination thereof. Using the input image 160, the one or more trained CN Ns 150 can generate one or more outputs. Using the sample input image, the trained CNNs 150 can generate, for example, one or more bounding boxes 170 around each detected product in the image, a segmentation mask 175 for each product in the input image, a classification or quality score of each product in the image 180, and a level of certainty or confidence score for the classification or quality score of each product in the image 185,

FIG. 3A-3C depicts a sample input image received by a trained CNN and the resulting outputs, according to some non-limiting embodiments. For example, as depicted in FIG. 3A, the trained CNN 150 can receive an input image comprising one or more products 210 shown in an input image, for example, cocoa beans as depicted in FIG. 3A. Using the methods described herein, the trained CNN 150 can generate outputs based on the received input image. FIG. 38 depicts displaying information related to a predicted classification of the one or more products depicted in the input image according to some non-limiting embodiments. One or more color-coded segmented products can be depicted in the output, wherein the appropriate color assigned to each product can predict the quality of the product (e.g., the freshness of a particular cocoa bean). The cross-hatching displayed in FIG. 3B is used to display color in the same manner as was explained for FIG. 2C, and which is also depicted in FIG. 3C. Thus, particular embodiments of the disclosed technology use color to display output classifications. FIG. 3C depicts displaying; information related to a predicted classification of the one or more products depicted in the input image, including corresponding confidence e scores, according to some non-limiting embodiments, FIG. 3C depicts one or more color-coded segmented products 330 along with an associated confidence score 335 for one or more products represented in the image. The confidence score can reflect a level of accuracy of the trained CNN 150's classification for each particular product in the input image. In other words, in certain embodiments the confidence score can reflect the system's confidence that the color coding of the associated cocoa bean is accurate.

As discussed above, in certain non-limiting embodiments, an input image 160 can be of one or more wet food products. The wet food products, for example, can be ‘chunk-in-gravy,’ ‘chunk-in-jelly,’ or ‘chunk-in-mousse.’ Runtime phase 120 can be used to detect and classify chunks included in the wet food product. For example, the wet food product can be classified based on one or more qualities of the chunks included therein.

In some non-limiting embodiments, the trained CNN 150 can be stored on and used with a computing system associated with a network, such that the trained CNN 150 can be accessed by a client device, through for example a mobile application, in some non-limiting embodiments a user can capture an input image using one or more cameras associated with the client device (e.g., a camera on a smartphone) and upload the input image to the network through a GUI on the mobile application. The GUI can comprise functionality that permits a to user to, for example, capture and upload image data, view output predictions, and transmit output functionality to one more other users. In some non-limiting embodiments, the captured input image can be associated with a time or a location, which can be inputted by the user or automatically obtained by accessing a current location of the client device. The input image 160 can then be presented to the trained CNN 150, which responds with one or more of the outputs disclosed herein. In some non-limiting embodiments this process can be run a client device with limited or no network connectivity, for example a computer or smartphone with limited cellular reception. The client device can receive the latest updated version of the trained CNN 150 from a computing system associated with a server. In other non-limiting embodiments the client device can transmit the presented input image 160 to the computing device on a network a server) via one or more links where the trained CNN 150 can perform the operations described herein. The server, for example, can be a cloud server. The computing device can utilize a machine learning tool, for example, the trained CNN 150, to predict outputs, for example the classification, quality score, or other parameters of one or more products in the input image. The computing device on the network then transmits the one or more outputs back to the client device.

In some non-limiting embodiments, the client device can capture the input image 160, wherein the input image 160 is an image of one of a batch or a shipment of cocoa beans. Based on the classifications generated by the system one or more classifications made according to particular techniques of the present disclosure), a server can transmit a recommendation to accept or reject the batch or the shipment of cocoa beans to the client device. In other embodiments, the recommendation can be generated at the client device. In either case, in some embodiments, the recommendation can be displayed on the client device, for example in a graphical user interface on a device display of the client device.

In a first example, the client device can be used by an employee of a company that produces foods such as chocolate or other confectionary products to take an image of a batch of cocoa beans. The employee can obtain a small sample of cocoa beans out of a batch and capture an image on the client device. An application executing on the client device (or a web app) can programmatically execute the techniques described herein with more specificity to classify one or more cocoa beans of the sample or batch. If the cocoa beans are determined to be inadequate based on the classification, which can comprise a predicted Brix measurement or any of the other outputs described herein, then the batch can be fagged by the application. Along with creating, a flag (for example, changing a status value of a variable persistently stored in a database), the application can generate a recommendation to reject the batch. In particular embodiments, the database can be a relational database, cloud storage, local hard drives, a data lake, a flat file, or another medium for persistent storage of digital electronic information. The recommendation can be in the form of a text message or an email to an individual or entity in charge of quality control (QC), and the email can be triggered and sent automatically, Or the recommendation could be batched for later processing according to a digitally stored execution schedule and sent along with other recommendations in a single email sent periodically at a specified time. In other embodiments, the recommendation can be in the form of a popup or notification on the client device, which can be a mobile device such as a mobile phone. The recommendation to reject the batch can also be based on one or more additional inputs besides the classification. For example, some embodiments can make the recommendation to reject the batch based on an origin, an age, a variety, a harvesting method, a processing method, or a fermentation method of the cocoa beans. These various inputs can also inform the system of which particular specialized machine learning models to execute, in certain embodiments. Similarly, the application can generate a recommendation to accept the batch when the classifications of the cocoa beans of the sample indicate that the batch of cocoa beans is acceptable.

In a second example, a distributer, supplier, intermediary, restaurant, supermarket, factory, or other receiving entity can receive a shipment of one or more food products, such as one or more cocoa beans. An employee of the receiving entity can inspect the shipment by capturing an image of a sample of the shipment using a client device. An application executing on the client device (or a web app) can programmatically execute the techniques described herein with more specificity to classify one or more cocoa beans of the sample or shipment. If the cocoa beans are determined to be inadequate based on the classification, which can comprise a predicted Brix measurement or any of the other outputs described herein, then the batch can be flagged by the application. Along with creating a flag (for example, changing a status value of a variable persistently stored in a database), the application can generate a recommendation to reject the shipment. In particular embodiments, the database can be a relational database, cloud storage, local hard drives, a data lake, a flat file, or another medium for persistent storage of digital electronic information. The recommendation can be in the form of a text message or an email to an individual or entity in charge of receiving, and the email can be triggered and sent automatically. In other embodiments, the recommendation can be in the form of a popup or notification on the client device, which can be a mobile device such as a mobile phone. The recommendation to reject the shipment can also be based on one or more additional inputs besides the classification. For example, some embodiments can make the recommendation to reject the shipment based on a price, a weight, or a color of the cocoa beans of the shipment, which can have been entered by the employee dynamically upon receiving the shipment and assessing one or more characteristics of the cocoa beans. These various inputs can also inform the system of which particular specialized machine learning models to execute, in certain embodiments. Similarly, the application can generate a recommendation to accept the shipment when the classifications of the cocoa beans of the sample indicate that the shipment of cocoa beans is acceptable.

In particular embodiments, the recommendation to reject or accept the bate, or shipment of cocoa beans can comprise a unique identifier associated with the batch or shipment. The recommendation can comprise other information such as the additional inputs used to make the recommendation as described herein), a predicted Brix measurement, a quality score, a confidence score, or a classification. In some-nonlimiting embodiments, a decision to accept or reject a hatch or shipment of cocoa beans can be based on a majority or threshold percentage of the cocoa beans having a certain predicted classification (e.g., “acceptable,” to accept or, “unacceptable,” to reject). In embodiments, a recommendation to reject the batch or shipment can be based on one or more beans not having a specific, associated predicted value exceeding a pre-determined threshold value, such as a threshold Brix measurement or a threshold quality score digitally stored in computer memory and being accessible by the client device. One non-limiting example of displaying the recommendation could be displaying a pop-up on the client device comprising text such as, “Batch: AC-7398; Origin: Indonesia; 23 beans in depicted sample . . . 7 beans acceptable, 16 beans unacceptable; Recommendation: REJECT; Confidence: 7 (high confidence); Time Stamp: 12/12/2021 at 10:23 a.m.”. In certain embodiments, information related to the recommendation can also be sent in an email, stored in a database or other storage medium, transmitted to another electronic device over a network, or otherwise processed to generate additional usable data. In certain embodiments, processing the image of the cocoa bean sample of the batch or shipment on-device and generating and displaying the recommendation locally as a pop-up saves processing resources, network bandwidth, memory, power consumption and other resources of a distributed cocoa bean information processing system, thereby improving the functioning of one or more computers of the distributed system operating in concert over a network.

In some non-limiting embodiments, the trained CNN 150 can be used to predict outputs for products during a particular unit of time or based on one or more inputted images. For example, a single prediction can be determined per image or for a given period of time. On the other hand, in other non-limiting embodiments rather than providing an output based on a particular period of time or a single image, the machine learning model or tool can run on an aggregated amount of data or multiple input images. The images received can be aggregated before being fed into the trained CNN 150, thereby allowing an analysis of a cumulative representation of products. The aggregation of data, for example, can break the data points into minutes of an hour, hour of a day, day of week, month of year, or any other periodicity that can ease the processing and help the modeling of the machine learning tool. When the data is aggregated more than once, there can be a hierarchy established on the data aggregation. The hierarchy can be based on the periodicity of the data bins in which the aggregated data are placed, with each reaggregation of the data reducing the number of bins into which the data can be placed.

For example, 288 images, which in some embodiments would be processed individually using small time windows, can be aggregated into 24 data points (for each hour of the day) for processing by the machine learning tool. In further examples, the aggregated data can be reaggregated into a smaller number of bins to help further reduce the number data points to be processed by the machine learning tool. By running on an aggregated amount of data can help to produce a cumulative or representative prediction. The other non-limiting embodiments can learn and model trends in a more efficient manner, reducing the amount of time needed for processing and improving accuracy. The aggregation hierarchy described above can also help to reduce the amount of storage. Rather than storing raw images or data that is lower in the aggregation hierarchy, some non-limiting embodiments can store images in a high aggregation hierarchy format.

In some other embodiments, the aggregation can occur after the machine learning process using the neural network, with the data merely being resampled, filtered, and/or transformed before it is processed by the machine learning tool. The filtering can include removing reference, such as brown noise or white noise. The resampling can include stretching or compressing the data, while the transformation can include flipping the axes of the received data. The transformation can also exploit natural symmetry of the data signals, such as left/right symmetry and different collar positions. In some embodiments, data augmentation can include adding noise to the signal, such as brown, pink, or white noise.

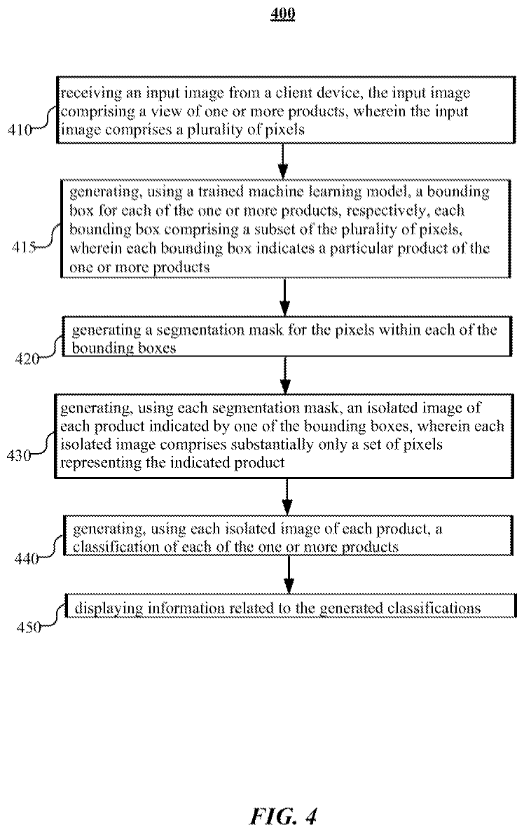

FIG. 4 illustrates an example computer-implemented method 400 for using machine learning systems to classify food products, according to some non-limiting embodiments. The method can begin at step 410 with receiving an input image from a client device, the input image comprising a view of one or more products, wherein the input image comprises a plurality of pixels. The input images could be photographic images, depth images (such as laser scans, millimeter wave data, etc.), 3D data projected into a 2D plane, thermal images, 2D sensor data, video, or any combination thereof. In some non-limiting embodiments a user can capture an input image using a client device using one or more cameras associated with the client device (e.g., a camera on a smartphone and upload the input image to the network through a GUI on the mobile application. The method 400 can execute step 415 with generating, using a trained machine learning model, a bounding box for each of the one or more products, respectively, each bounding box comprising a subset of the plurality of pixels, wherein each bounding box indicates a particular product of the one or more products. The method 400 can execute step 420 with generating a segmentation mask for the pixels within each of the bounding boxes. The method 400 can execute step 430 with generating, using each segmentation mask, an isolated image of each product indicated by one of the bounding boxes, wherein each isolated image comprises substantially only a set of pixels representing the indicated product. The method 400 can execute step 440 with generating, using each isolated image of each product, a classification of each of the one or more products. The method 400 can execute step 450 with displaying information related to the generated classifications.

Certain non-limiting embodiments can repeat one or more steps of the method of FIG. 4, where appropriate. Although this disclosure describes and illustrates particular steps of the method of FIG. 4 as occurring in a particular order, this disclosure contemplates ally suitable steps of the method of FIG. 4 occurring in any suitable order. Moreover, although this disclosure describes and illustrates an example method for using machine learning systems to classify food products including the particular steps of the method of FIG. 4, this disclosure contemplates any suitable method for using machine learning systems to classify food products including any suitable steps, which can include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

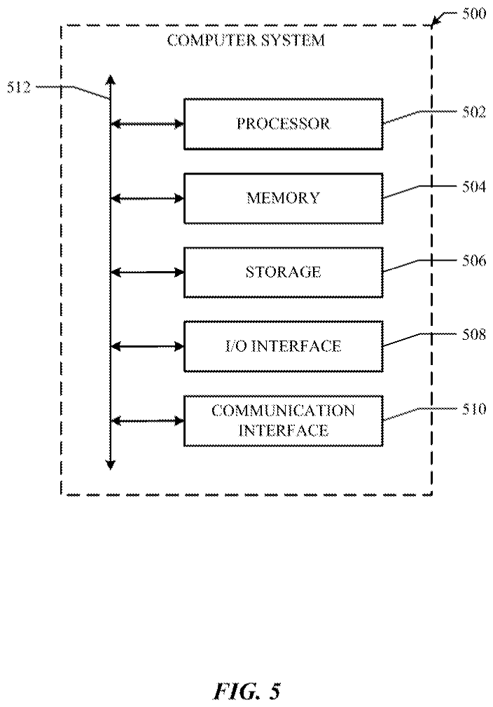

FIG. 5 illustrates an example computer system 500 used to facilitate prediction of product classifications using machine learning tools, according to some non-limiting embodiments. In certain non-limiting embodiments, one or more computer systems 500 perform one or more steps of one or more methods described or illustrated herein. In certain other non-limiting embodiments, one or more computer systems 500 provide functionality described or illustrated herein. In certain non-limiting embodiments, software running on one or more computer systems 500 performs one or more steps of one or more methods described or illustrated herein or provides functionality described or illustrated herein. Some non limiting embodiments include one or more portions of one or more computer systems 500. Herein, reference to a computer system can encompass a computing device, and vice versa, where appropriate. Moreover, reference to a computer system can encompass one or more computer systems, where appropriate.

This disclosure contemplates any suitable number of computer systems 500, This disclosure contemplates computer system 500 taking any suitable physical form. As example and not by way of limitation, computer system 500 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented; virtual reality device, or a combination of two or more of these, Where appropriate, computer system 500 can include one or more computer systems 500; be unitary or distributed; span multiple locations; span multiple machines; span multiple data centers; or reside in a cloud, which can include one or more cloud components in one or more networks. Where appropriate, one or more computer systems 500 can perform without substantial spatial or temporal limitation one or more steps of one or more methods described or illustrated herein. As an example, and not by way of limitation, one or more computer systems 500 can perform in real time or in batch mode one or more steps of one or more methods described or illustrated herein. One or more computer systems 500 can perform at different times or at different locations one or more steps of one or more methods described or illustrated herein, where appropriate.

In certain non-limiting embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In some non-limiting embodiments, processor 502 includes hardware tor executing instructions, such as those making up a computer program. As an example and not by way of limitation, to execute instructions, processor 502 can retrieve (or fetch) the instructions from an internal register, an internal cache, memory 504, or storage 506; decode and execute them; and then write one or more results to an internal register, an internal cache, memory 504, or storage 506. In certain non-limiting embodiments, processor 502 can include one or more internal caches for data, instructions, or addresses. This disclosure contemplates processor 502 including any suitable number of any suitable internal caches, where appropriate. As an example, and not by way of limitation, processor 502 can include one or more instruction caches, one or more data caches, and one or more translation lookaside buffers (TLBs). Instructions in the instruction caches can be copies of instructions in memory 504 or storage 506, and the instruction caches can speed up retrieval of those instructions by processor 502. Data in the data caches can be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches can speed up read or write operations by processor 502. The TLBs can speed up virtual-address translation for processor 502. In some non-limiting embodiments, processor 502 can include one or more internal registers for data, instructions, or addresses. This disclosure contemplates processor 502 including any suitable number of any suitable internal registers, where appropriate. Where appropriate, processor 502 can include one or more arithmetic logic units (ALUs); be a multi-core processor; or include one or more processors 502. Although this disclosure describes and illustrates a particular processor, this disclosure contemplates any suitable processor.

In some non-limiting embodiments, memory 504 includes main memory for storing instructions for processor 502 to execute or data for processor 502 to operate on. As an example and not by way of limitation, computer system 500 can load instructions from storage 506 or another source (such as, for example, another computer system 500) to memory 504. Processor 502 can then load the instructions from memory 504 to an internal register or internal cache. To execute the instructions, processor 502 can retrieve the instructions from the internal register or internal cache and decode them. During or after execution of the instructions, processor 502 can write one or more results (which can be intermediate or final results) to the internal register or internal cache. Processor 502 can then write one or more of those results to memory 504. In some non-limiting embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which can each include au address bus and a data bus) can couple processor 502 to memory 504. Bus 512 can include one or more memory buses, as described below. In certain non-limiting embodiments, one or more memory management units (MMUs) reside between processor 502 and memory 504 and facilitate accesses to memory 504 requested by processor 502. In certain other non-limiting embodiments, memory 504 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable. RAM. Memory 504 can include one or more memories 504, where appropriate. Although this disclosure describes and illustrates a particular memory component, this disclosure contemplates any suitable memory.

In some non-limiting embodiments, storage 506 includes mass storage for data or instructions. As an example and not by way of limitation, storage 506 can include a hard disk drive (HDD), a floppy disk drive, flash memory, an optical disc, a magneto-optical disc, magnetic tape, or a Universal Serial Bus (USB) drive or a combination of two or more of these. Storage 506 can include removable or non-removable (or fixed) media, where appropriate, Storage 506 can be internal or external to computer system 500, where appropriate. In certain non-limiting embodiments, storage 506 is non-volatile, solid-state memory. In some non-limiting embodiments, storage 506 includes read-only memory (ROM) Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 can include one or more storage control units facilitating communication between processor 302 and storage 506, where appropriate. Where appropriate, storage 506 can include one or more storages 506. Although this disclosure describes and illustrates particular storage, this disclosure contemplates any suitable storage.

In certain non-limiting embodiments, I/O interface 508 includes hardware, software, or both, providing one or more interfaces for communication between computer system 500 and one or more I/O devices. Computer system 500 can include one or more of these I/O devices, where appropriate. One or more of these I/O devices can enable communication between a person and computer system 500, As an example and not by way of limitation, an device can include a keyboard, keypad, microphone, monitor, mouse, printer, seamier, speaker, still camera, stylus, tablet, touch screen, trackball, video camera, another suitable I/O device or a combination of two or more of these. An I/O device can include one or more sensors. This disclosure contemplates any suitable I/O devices and any suitable I/O interfaces 508 for them. Where appropriate, I/O interface 508 can include one or more device or software drivers enabling processor 502 to drive one or more of these LO devices. I/O interface 508 can include one or more. LO interfaces 508, where appropriate. Although this disclosure describes and illustrates a particular I/O interface, this disclosure contemplates any suitable I/O interface.

In some non-limiting embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As au example, computer system 500 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 can include any suitable communication interface 510 for any of these networks, where appropriate, Communication interface 510 can include one or more communication interfaces 510, where appropriate, Although this disclosure describes and illustrates a particular communication interface, this disclosure contemplates any suitable communication interface.

In certain non-limiting embodiments, bus 512 includes hardware, software, or both coupling components of computer system 500 to each other. As an example and not by way of limitation, bus 512 can include an Accelerated Graphics Port (AGP) or other graphics bus, an Enhanced Industry Standard Architecture (EISA) bus, a front-side bus (FSB), a HYPERTRANSPORT (HT) interconnect, an industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 can include one or more buses 512, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

In some non-limiting embodiments, the methods and systems described herein can be used to replace or augment the cut-test method of cocoa bean quality assessment. The cut-test is a highly manual and subjective assessment of dry beans to grant approval of cocoa beans for liquor production, commonly known as the ‘out test’. This test involves physically cutting numerous individual beans in half to expose the inner surfaces where quality parameters can be analyzed. Bean size, internal mold, infestation, and internal color (as an indication of degree of fermentation and subsequently flavor) are all industry standard measures to determine the quality and marketability of a given lot of cocoa. The methods and systems herein can be used to conduct these assessments removing much of the subjectivity and labor associated with assessing large numbers of individual beans to determine the quality and degree of fermentation in cocoa.

In some non-limiting embodiments, the methods and systems described herein can h used to manage and identify pest and disease problems in cacao farms.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context, Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments can include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, al though this disclosure describes or illustrates some non-limiting embodiments as providing particular advantages, certain non-limiting embodiments can provide none, some, or all of these advantages.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

The embodiments disclosed herein are only examples, and the scope of this disclosure is not limited to them. Certain non-limiting embodiments can include all, some, or none of the components, elements, features, functions, operations, or steps of the embodiments disclosed above. Embodiments are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

1. A computer-implemented method comprising:
receiving an input image from a client device, the input image comprising a view of one or more products, wherein the input image comprises a plurality of pixels;
generating, using a trained machine learning model, a bounding box for each of the one or more products, respectively, each bounding box comprising a subset of the plurality of pixels, wherein each bounding box indicates a particular product of the one or more products;
generating a segmentation mask for the pixels within each of the bounding boxes;
generating, using each segmentation mask, an isolated image of each product indicated by one of the bounding boxes, wherein each isolated image comprises substantially only a set of pixels representing the indicated product;
generating, using each isolated image of each product, a classification of each of the one or more products; and
displaying information related to the generated classifications.

2. The computer-implemented method of claim 1, wherein the machine learning model was trained using a collection of annotated images, each annotated image of the collection of annotated images comprising a view of a set of products of a product type of the one or more products.

3. The computer-implemented method of claim 1, wherein the one or more products comprise one or more cocoa beans.

4. The computer-implemented method of claim 3, wherein the one more cocoa beans comprise wet beans.

5. The computer-implemented method of claim 4, wherein at least one of the classifications of one of the products comprises one of acceptable, germinated, damaged by pests, or diseased.

6. The computer-implemented method of claim 4, wherein at least one of the classifications of one of the products relates to freshness.

7. The computer-implemented method of claim 1, further comprising predicting a Brix measurement for one or more of the one or more products, wherein at least one of the classifications of one of the products is based at least in part on the predicted Brix measurement.

8. The computer-implemented method of claim 1, further comprising:
predicting a Brix measurement for one or more of the one or more products; and
generating a quality score for one or more of the one or more products based at least in part on the predicted Brix measurement.

9. The computer-implemented method of claim 3, wherein the one more cocoa beans comprise dry beans.

10. The computer-implemented method of claim 9, wherein at least one of the classifications of one of the products is at least partly based on a predicted quality comprising one of an amount of moisture, a Cut Test: Clumps test result, a Cut Test: Mold test result, a Cut Test: Flats test result, a Cut Test: Color test result, a Cut Test: Infestation test result, a bean size, a Foreign Matter test result, an indication of a broken bean, or a bean count.

11. The computer-implemented method of claim 3, further comprising receiving one or more additional inputs, wherein the one or more additional inputs comprise at least one of an origin, an age, a variety, a price, a harvesting method, a processing method, a weight, or a fermentation method, and wherein the classification is at least partly based on the one or more additional inputs.

12. (canceled)

13. The computer-implemented method of claim 1, further comprising receiving one or more updates to the trained machine learning model over the network, wherein the network comprises a cloud server.

14. The computer-implemented method of claim 11, further comprising:
generating a recommendation to reject one of a batch or a shipment of cocoa beans based at least in part on the classification of each of the one or more products; and
displaying the recommendation on the client device.

15. The computer-implemented method of claim 1, further comprising generating and displaying a confidence score, wherein the confidence score is associated with the one of the classifications of one of the products.

16. One or more computer-readable non-transitory storage media embodying software that is operable when executed to:
receive an input image from a client device, the input image comprising a view of one or more products, wherein the input image comprises a plurality of pixels;
generate, using a trained machine learning model, a bounding box for each of the one or more products, respectively, each bounding box comprising a subset of the plurality of pixels, wherein each bounding box indicates a particular product of the one or more products;
generate a segmentation mask for the pixels within each of the bounding boxes;
generate, using each segmentation mask, an isolated image of each product indicated by one of the bounding boxes, wherein each isolated image comprises substantially only a set of pixels representing the indicated product;
generate, using each isolated image of each product, a classification of each of the one or more products; and
display information related to the generated classifications.

17. The storage media of claim 16, wherein the machine learning model was trained using a collection of annotated images, each annotated image of the collection of annotated images comprising a view of a set of products of a product type of the one or more products.

18. The storage media of claim 16, wherein the one or more products comprise one or more cocoa beans.

19. The storage media of claim 18, wherein the one more cocoa beans comprise wet beans.

20. The storage media of claim 19, wherein at least one of the classifications of one of the products comprises one of acceptable, germinated, damaged by pests, or diseased.

21-45. (canceled)
